(19) United States
(12) Patent Application Publication
(10) Pub. No.: US 2009/0141213 A1
(43) Pub. Date: Jun. 4, 2009

(54) LARGE-SCALE DISPLAY DEVICE

(75) Inventor: KUAN HER CHIU, CHANGHUA COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: ADVANCED OPTOELECTRONIC TECHNOLOGY INC., HSINCHU COUNTY (TW)

(21) Appl. No.: 12/325,069

(22) Filed: Nov. 28, 2008

(30) Foreign Application Priority Data
Nov. 29, 2007 (TW) 096145302

(51) Int. Cl. G02F 1/133

(52) U.S. Cl. 349/73

(57) ABSTRACT

The present invention discloses a large-scale display device, which comprises a first display unit, a second display unit, a black margin area between the first display unit and the second display unit, and two polarizers attached to two surfaces of the first and second display units. The second display unit is arranged in parallel to the first display unit.

### BACKGROUND OF THE INVENTION

(A) Field of the Invention

The present invention is generally related to a large-scale display device, and more particularly to a display device featuring increased active area size, better resolution at the display panel margins, and increased pixel aperture ratio to provide higher resolution and better light transmission ratio.

(B) Description of the Related Art

A traditional TFT-LCD panel is fabricated by means of a forepart array process to form thin film transistors on a glass (TFT substrate), and an intermediate cell process to fasten and seal the TFT substrate to another glass with color filter thereon (CF substrate). Liquid crystal is then injected into the space between the TFT substrate and CF substrate to form an active area, wherein each pixel includes red (R), green (G), and blue (B) colors. When electric current flows through the transistors to generate electric field variations to cause rotation of liquid crystal molecules, polarity of light is changed. Two polarizers are used to determine the on/off state of each pixel, and collectively the set of RGB pixels form an image appearing on the display panel.

The resolution of a conventional TFT-LCD panel is determined by the number of pixels in the active area. For example, active area of a 42-inch TFT-LCD panel has dimensions of about 930.3 mm×523.0 mm. If such a panel has resolution equal to WXGA (1366×768), i.e. the long axis of the active area has 1366 pixels with length 0.681 mm per pixel, and the short axis of the active area has 768 pixels with length 0.681 mm per pixel, the area of each pixel is equal to 0.681 mm×0.681 mm=0.464 mm². To increase the resolution of the TFT-LCD panel without changing its size, the area of each pixel has to be decreased.

For example, a 42-inch TFT-LCD panel has active area dimensions of about 930.3 mmm×523.0 mm. In order to increase the resolution to full HD standard (1920×1080), i.e. in which the long axis of the active area has 1920 pixels with length 0.485 mm per pixel, and the short axis of the active area has 1080 pixels with length 0.484 mm per pixel, then the area of each pixel should be reduced to 0.485 mm×0.484 mm=0.235 mm².

Generally, the resolution of a TFT-LCD panel is inversely related to the light transmission ratio of the panel, because higher resolution of the same size panel relates to a smaller area of each pixel. Further, thin film transistor and circuits will relatively occupy more area, with a smaller aperture area for each pixel. To sum up, considering identical 42-inch panels with active-area dimensions of about 930.3 mm×523.0 mm, resolutions of WXGA and full HD are 1366×768 and 1920×1080 respectively. Hence, the pixel illuminating area of full HD can be calculated at 50.6% of that of WXGA. Due to the smaller emitting area of the pixel area, the aperture ratio is smaller. Therefore, light transmission of TFT-LCD panel is decreased, and much more light energy for BLU (back light unit) should be applied to meet specifications of panel luminance.

Moreover, although LCD panels can be arranged in parallel to increase display area using current TFT-LCD technology, the interface between panels still has pixels that can display the image. Even if panel size is increased, array and cell processes cannot assemble mass panels. Although panel resolution can be increased, panel transmission ratio requirements cannot be met simultaneously. A challenge in the TFT-LCD industry is the pursuit of increasingly large panel sizes, as well as higher resolution, resulting in smaller and smaller pixel aperture ratios. Even if the aperture ratio of each pixel is increased by enlarging panel size, gain is limited. Both panel resolution and light transmission cannot be increased simultaneously.

### SUMMARY OF THE INVENTION

One aspect of the present invention is to increase the resolution of both the active area of a display device and the margin of the display panel. Furthermore, it achieves both increased panel resolution and improved transmission ratio simultaneously. Therefore, the present invention has the economic advantages for industrial applications.

Accordingly, the present invention discloses a large-scale display device, which comprises a first display unit with a first thin film transistor substrate and a first color filter substrate corresponding thereto, a second display unit with a second thin film transistor substrate next to the first color filter substrate and a second color filter substrate next to the first thin film transistor substrate, a black margin area between the first display unit and the second display unit, and two polarizers attached to two surfaces of the first and second display units. The second display unit is arranged parallel to the first display unit.

### BRIEF DESCRIPTION OF THE DRAWINGS

The objectives and advantages of the present invention will become apparent upon reading the following description and upon reference to the accompanying drawings in which:

FIG. 1 is a schematic diagram of a top view of one embodiment of the present invention;

FIG. 2 is a schematic diagram of a cross sectional view of one embodiment of the present invention;

FIG. 3 is a schematic diagram of a cross sectional view of the first display unit according to one embodiment of the present invention; and

FIG. 4 is a view along the A-A line of FIG. 1 according to one embodiment of the present invention.

### DETAILED DESCRIPTION OF THE INVENTION

The present invention describes a large-scale display device. Detailed descriptions of the structure and elements are provided in order to make the invention thoroughly understood. Obviously, the application of the invention is not limited to specific details provided herein; the common structures and elements that are known to those who are skilled in the art are not described in detail to avoid unnecessary limitations of the invention.

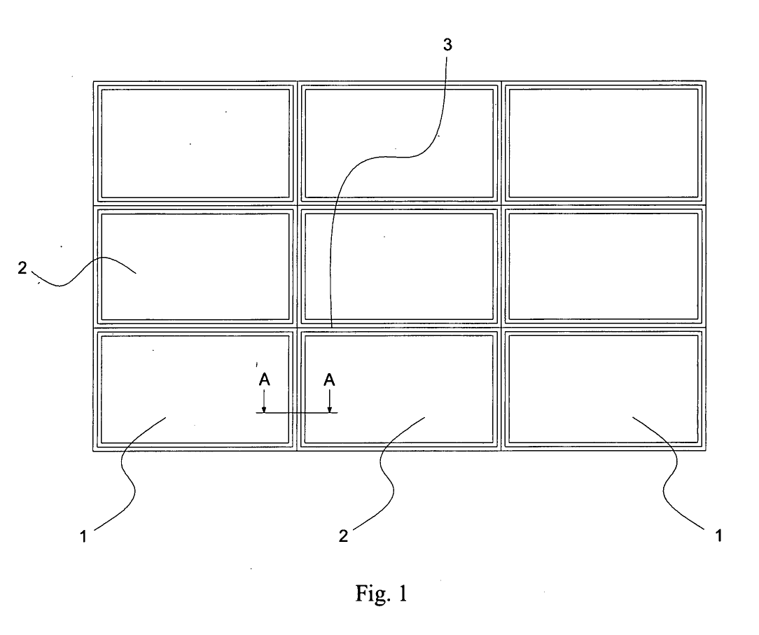

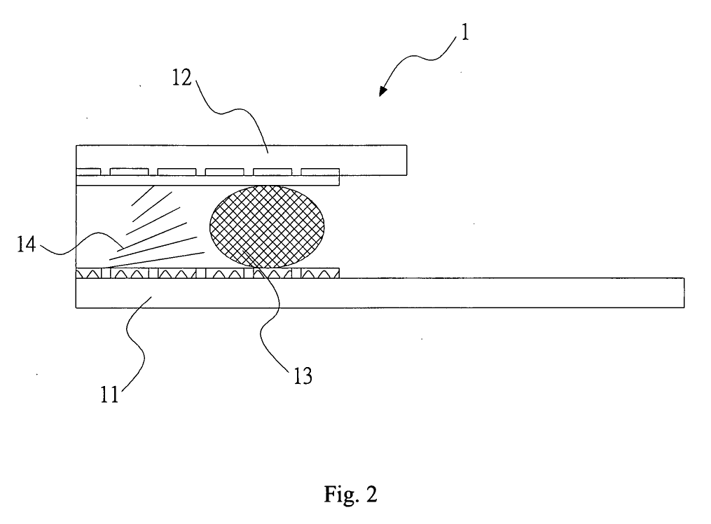

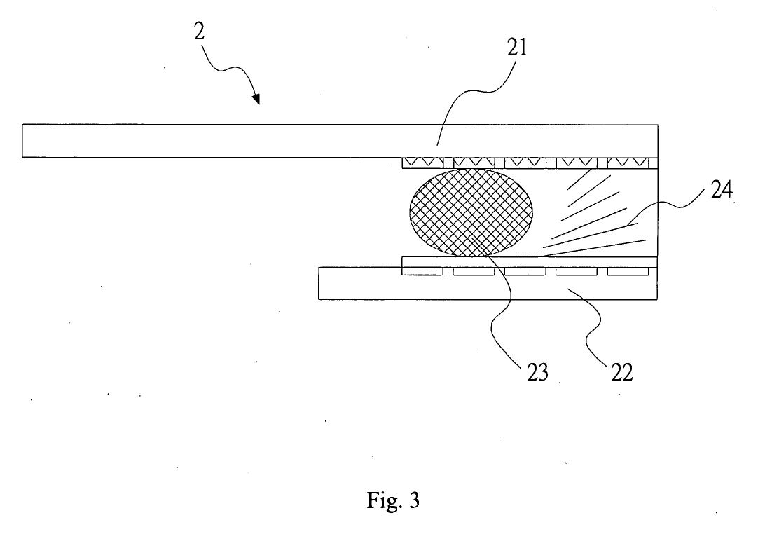

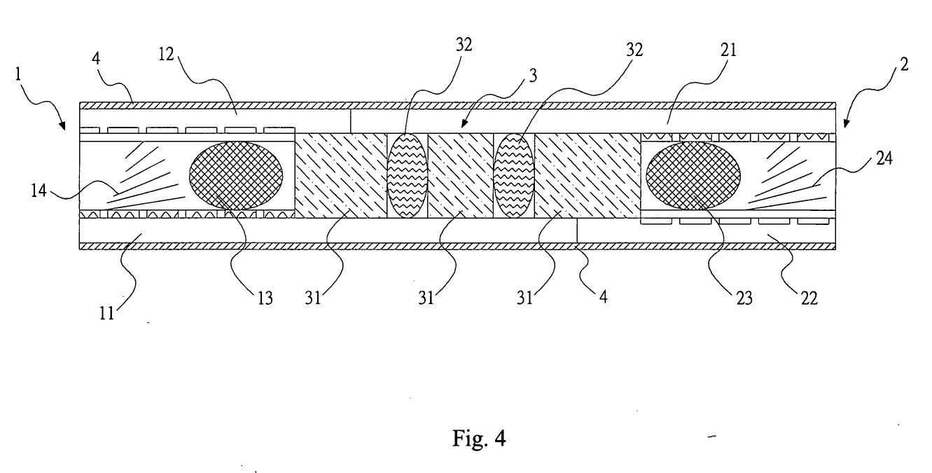

Please refer to FIG. 1, FIG. 2, FIG. 3 and FIG. 4, in which the present invention is illustrated by schematic diagrams of a top view, a sectional view to the first display unit, a sectional view to the second display unit, and a cross-sectional view along the A-A line of FIG. 1. This invention provides a large-scale display device including at least a first display unit 1, at least a second display unit 2, black margin areas 3, and polarizer 4.

The first display unit 1 comprises a first thin film transistor substrate 11 (TFT substrate), a first color filter substrate 12 (CF substrate), a spacer 13 between the first TFT substrate 11 and first CF substrate 12, and liquid crystal 14 filled within the space bounded by the first TFT substrate 11 and first CF substrate 12. The spacer 13 is used for liquid crystal 14 rotation.

The second display unit 2 is arranged parallel to the first display unit. The second display unit 2 comprises a second thin film transistor substrate 21 (TFT substrate), a second color filter substrate 22 (CF substrate), a spacer 23 between the second TFT substrate 21 and second CF substrate 22, and liquid crystal 24 filled within the space bounded by the second TFT substrate 21 and second CF substrate 22. The spacer 23 is used for liquid crystal 24 rotation.

The black margin areas 3 are located between the first display unit 1 and the second display unit 2, and include a combination portion 31 to assemble the first display unit 1 and the second display unit 2, and a connection portion 32 to electrically connect the first TFT substrate 11 to the second TFT substrate 21 or to electrically connect the first CF substrate 12 to the second CF substrate 22. The combination portion includes opaque gel and the connection portion includes conduction epoxy.

The polarizers 4 are fastened to two surfaces of the first display unit 1 and the second display unit 2. A larger-scale display device is then provided.

When the large-scale display device is in operation, it uses two or more of the first display unit 1 and the second display unit 2 to assemble a TV wall by combining, stacking or fastening. A control-circuit unit 5 is connected between the first TFT substrate 11 and the second TFT substrate 21. The control-circuit unit 5 attaches to Flexible Print Circuit by lead, and being a transmitter to paralleling connect with each other, and then be controlled by a central system (not shown in Figs). The large display unit with a backlight module forms a large-scale display device. The first display unit 1 and the second display unit 2 are arranged in parallel and fastened at the same resolution, and are stacked to form a TV wall to increase the size of the integral active region of the first and second display units 1, 2 of the present invention. The resolution of the panel margin can be increased also. The black margin area 3 between the first display unit 1 and the second display 2 serves no function, and hence the area of each pixel can be increased significantly. The aperture of each pixel is therefore enlarged in the first display unit 1 and the second display unit 2, and the transmission ratio is also improved. Both resolution and transmission ratio of the first display unit 1 and the second display unit 2 can be increased simultaneously. When the transmission ratio is increased, the total energy of the back light unit is decreased.

When two or more of the first display unit 1 and the second display unit 2 are combined or fastened, the upper CF substrate 12 and the lower TFT substrate 11 are upside down and staggered, or are piled up corresponding to the TFT substrate 11 of the first display unit 1 and the CF substrate 22 of the second display unit 2.

One the other hand, the CF substrate 12 of the first display unit 1 is next to the TFT substrate 22 of the second display unit 2. A connection portion 32 including silver epoxy provides electrical connection in circuits, and a combination portion 31 including opaque gel provides assembly or fastening function. The outer polarizers 4 attached on the two surfaces of the first display unit 1 and the second display unit 2 can also increase the binding force.

The present invention is assembled by two or more of the first display unit 1 and the second display unit 2. The panel size can correspond with next generation of panel manufacturers, such as the 10^{th} generation glass substrate having various assemblies, for example, vertical array, horizontal array or matrix array. According to the above, a large-scale display unit with a backlight module can form a large-scale display device. The large-scale display device mainly applies in both indoor and outdoor applications, such as TV walls or display boards. Thus, manufacturing cost and integral product reliability is of importance, and specifications of panel brightness can be met more easily.

Obviously, many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A large-scale display device, comprising:
a first display unit comprising a first thin film transistor substrate and a first color filter substrate corresponding thereto;
a second display unit comprising a second thin film transistor substrate next to the first color filter substrate and a second color filter substrate next to the first thin film transistor substrate, the second display unit being arranged parallel to the first display unit;
a black margin area between the first display unit and the second display unit; and
two polarizers attached to two surfaces of the first and second display units.

2. The large-scale display device of claim 1, further comprising a plurality of spacers and liquid crystal between the first thin film transistor substrate and the first color filter substrate in the first display unit.

3. The large-scale display device according to claim 1, further comprising a plurality of spacers and liquid crystal between the second thin film transistor substrate and the second color filter substrate in the second display unit.

4. The large-scale display device according to claim 1, further comprising a control circuits unit connecting to the first display unit and the second display unit.

5. The large-scale display device according to claim 1, wherein the control circuits unit is fastened to the flexible printed circuit board by means of lead.

6. The large-scale display device according to claim 1, further comprising a combination portion in the black margin area to combine the first display unit and the second display unit, and a connection portion to electrically connect the first display unit to the second display unit.

7. The large-scale display device according to claim 6, wherein the combination portion comprises opaque gel.

8. The large-scale display device according to claim 6, wherein said connection portion comprises conduction epoxy.
